(19) United States
(12) Patent Application Publication
(10) Pub. No.: US 2012/0070798 A1
(43) Pub. Date: Mar. 22, 2012

(54) LIGHT PROTECTION SHIELD FOR LIGHT DELIVERY SYSTEM

(76) Inventor: Neil Teitelbaum, Ottawa (CA)

(21) Appl. No.: 12/887,744

(22) Filed: Sep. 22, 2010

(51) Int. Cl. A61C 19/00

(52) U.S. Cl. 433/29

(57) ABSTRACT

A dental shield for lessening unwanted hazardous reflections of light in a wavelength band between 400 nm and 500 nm. The dental shield is similar to a traditional shield used on a hand held light delivery device, however the shield is antireflective coated on one or both sides to protect the non-user of the shield; the patient, so that harmful reflections into the patient's eyes can be lessened. The filter prevents at least 98% of UV or blue light from being reflected.

### FIELD OF THE INVENTION

This invention relates to a light-shielding device for use with light curing apparatus employed for dental restoration.

### BACKGROUND

In the process of forming veneers on teeth requiring restoration, or in the process of providing fillings, composite resin materials are applied and cured by application of light of a selected wavelength. Previously ultraviolet light was employed to effectuate such curing, but it was recognized that ultraviolet radiation is harmful to human skin and eye tissues. As a result, visible light curing units were developed and it was generally believed that the problem of harmful radiation effects had been obviated.

The wavelength of light employed by such visible light curing units used to polymerize composite resins is in the range of about 460-480 nanometers, which is extremely damaging to the human eye. This spectrum of visible light contains a component designated as “blue light.” Blue light will cause retinal burns after very short exposures of less than one second. As the time of exposure is increased, the burns become more severe. This damage is called solar retinitis. Retinal burns appear 48 hours after light exposure, and although healing occurs in 20-30 days, the healed areas experience permanently degenerative tissues. This damage to the retina is irreparable, and the damaged rod and cone photoreceptors cannot be regenerated.

It is known that 510 nanometers is considered the minimal cutoff point for severe eye damage. Shorter wavelengths, as those essential to cure composite resins, are much more dangerous than longer wavelengths. For example, a wavelength of 441 nanometers is 2.5 times more damaging than 488 nanometers.

Extended exposure to very low levels of blue light at 463 nm, the same wavelength used to cure composites, can cause permanent blue blindness. Repeated exposures to very low levels of blue light can produce retinal injury.

In most situations in dental clinics, the blue light that reaches the eyes is reflected light. Although some scientists feel that reflected light is less harmful to the eye than direct light, the recommendation is to use eye protection to screen both direct and reflected light. This protection has been implemented in various ways, which may not be totally effective.

For example, the dental clinician may cover the curing region of the applied light with the reflective side of a mouth mirror in order to reflect the light against the restorative area to improve curing. However, this puts the onus on the clinician who may be distracted or who may forget to do this.

In other cases, optical glasses are used in order to look at the lamp source for proper placement against the tooth. However, most optical glasses transmit blue light and near ultraviolet light radiation with minimal attenuation. There are special orange lensed glasses that do protect eyes from UV and blue light between 400 and 510 nm which meet OSHA requirements and ANSI Z87.1. These are sold by Epak Electronics Ltd. Millfield Estate, Chard, Somerset TA20 2BB United Kingdom.

However, these approaches suffer from awkwardness and affect the efficiency of the dental clinician, as well as being harmful and dangerous to the eyes of the patient.

It would be desirable to have a simple and effective means to shield the harmful radiation from the eyes of the patient and the operating clinician which can be expediently used in combination with the light curing apparatus.

For well over a decade dentists have used light curing instruments such as one described in the form of a gun or more recently in the form of a wand with a tip for directing visible light having wavelengths harmful to retinas, wherein the instrument has a UV or blue light filter in the form of an orange removable shield. Such an instrument is shown in FIG. 1, where the shield 16 can be removed from the light delivery device 10. Although these shields may perform their intended function of protecting dentist's eyes, there is a significant drawback to this design as the shield can be harmful to patients.

The shield 16 is designed to be removable so that in some instances when it is difficult to place the device in the patient's mouth the shield is removed and hand held by the dentist. Although this may provide adequate protection for the dentist, the side of the shield closest to the patient's eyes may reflect the harmful blue or UV light directly into the patient's eyes. The light scattered by the teeth surface can be reflected by the removable hand held shield into the patient's eyes

I became aware of this disadvantage of the conventional curing instrument during a visit to my dentist.

The orange protective shield mounted on my dentist's light curing gun was removed so that the instrument could fit inside my mouth and the orange shield was hand held above my head so that the eyes of the clinician could be protected as they peered through the orange transparent shield. During a routine filling procedure, I looked up I saw an attractive blue light. My eyes fixated onto it for several seconds before I realized that this light could be harmful to my retinas, and I subsequently looked away. The light I was looking at was reflected from the glossy surface of the orange filter that was removed from the light delivery device and was hand held by my dentist's assistant.

It occurred to me that dental practitioners know that one should not look into UV light or blue light as they use this light delivery system daily, however the general patient population may have reacted as I did or may look at it for even longer not realizing the potential danger to their eyes. It is natural for one to try and focus on a light so as to resolve it and have the brain translate it into color. It is even mesmerizing and sometimes pleasurable to stare at such a beam so see the patterns that form, all this time perhaps unknowingly doing severe damage to one's retinas.

It is an object of this invention to obviate or lessen this problem so as to reduce damage and the likelihood of damage to patient's eyes when a light curing system is used.

In accordance with this invention there is provided a dental instrument for delivering light having a removable eye protection shield in the form of a filter for blocking at least 95% of UV or blue light emitted by the dental instrument, wherein the shield has an antireflective coating on at least one side thereof for preventing at least 98% of UV or blue light incident thereon from being reflected.

In accordance with an aspect of this invention an orange light shield is provided for protecting a clinician's eyes from harmful rays while looking through the shield, wherein the filter is coated on one or both sides with an antireflection coating for protecting the patient's eyes wherein the filter is sized to be held in a holder of a light delivery gun or wand.

### BRIEF DESCRIPTION OF THE DRAWINGS

Exemplary embodiments of the invention will now be described in conjunction with the drawings in which:

FIG. 1 is a prior art a top front, right-side perspective view of a light delivery system for providing light for curing dental material.

FIG. 2 is a cross sectional view of a transparent light protecting shield in accordance with the invention.

FIG. 3 is a graph of wavelength versus reflectance for and antireflection coating capable of reducing back reflections from the eye protection shield of this invention.

### DETAILED DESCRIPTION

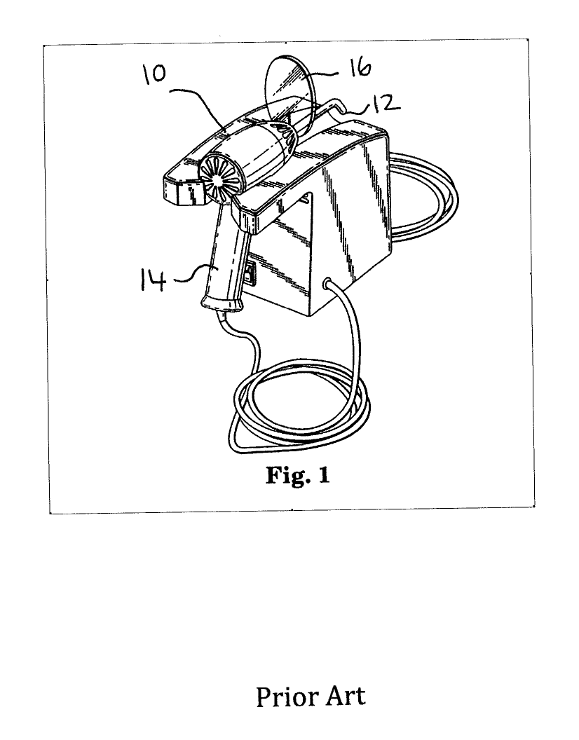

Referring now to FIG. 1 a light delivery system 10 is shown, having a tip 12, a handle 14 and a shield 16 in the form of a filter for preventing most harmful radiation from passing to the operators eyes while allowing the operator to view the tip 12 while irradiating a tooth to be filled. The shield is in the form of an orange filter, typically capable of suppressing 99.9% of the blue or UV spectrum in order to protect an operator's eyes. In most instances, back reflection reaching the filter or shield 16 is not particularly hazardous as these reflections are directed into the patient's mouth.

However, since the shield 16 is removable and is often hand held, reflections into the patient's eyes often occur. A substantially transparent surface such as glass or acrylic at moderate angles of incidence will reflect approximately 4% of incident light.

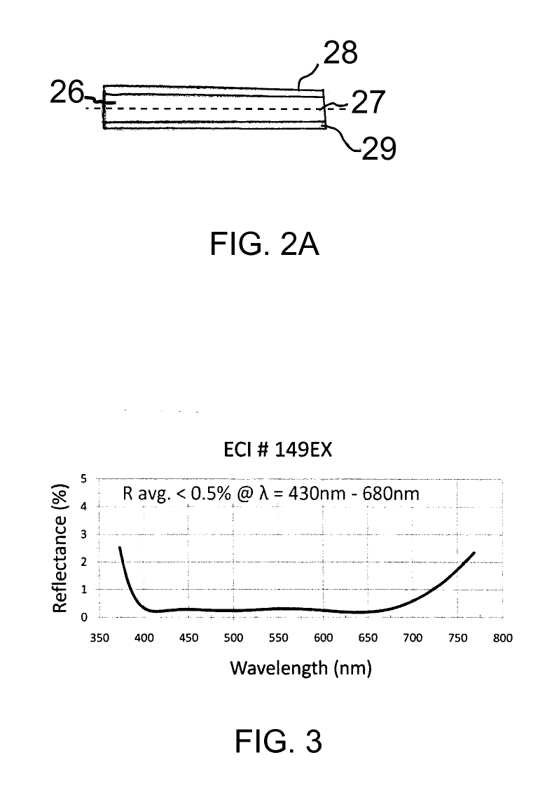

Turning now to FIG. 2, a filter or shield 26 is shown having an antireflective (AR) coating applied to both sides thereof. This AR coating only allows 0.5% of the light incident directly thereon to be reflected.

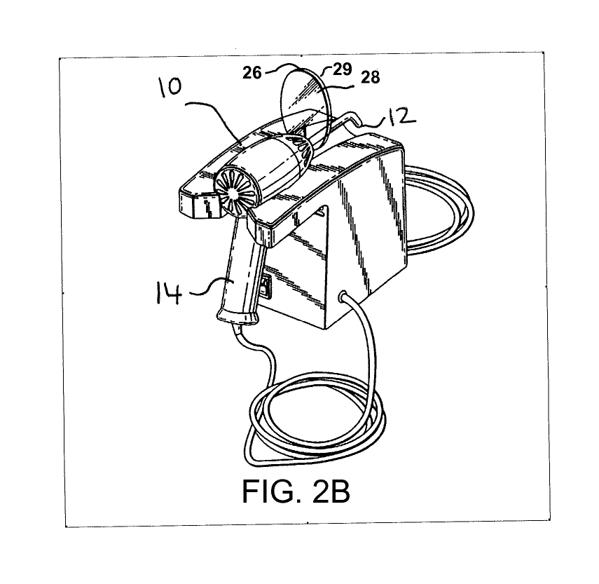

FIG. 3 shows the output spectrum for this filter shield 26. The discovery that patients often stare at the shield designed to protect the dentist led to the realization that this AR coating applied to the non viewing side of the shield can severely limit injuries that may otherwise occur. It is acknowledged that AR coatings are known and are generally used in lenses to provide less reflection for the observer or user of these lenses. However, the AR coating in this application is provided to protect the unaware, unsuspecting patient located on the non-viewing side of the lens, for whom the prior art lens is not designed to protect.

FIG. 3 is a graph of the output of an AR filter illustrating that reflectance of wavelengths incident upon the filter between 400 nm and 650 nm are significantly attenuated. Filter coatings can be applied to glass or plastic substrates using one or more thin film coatings. The particular filter spectrum shown is a commercially available coating, which can be obtained from Evaporated Coatings inc., of Willow Grove, Pa..

In accordance with a preferred embodiment of this invention both sides of the shield 26 should be antireflection coated so that if the filter were inadvertently flipped over, protection would be offered from either side. This can be important since on some devices the filter can be reseated in its holder with either side of the filter facing the operator and in many instances the filter appears the same from both sides. Alternatively, an indication can be provided on the filter to indicate the viewing side and the side which is coated with the AR filter that is to be directed towards the patient.

In some instances light emitted from the light delivery device, for example UV light can even be harmful to the patent's skin or soft tissue and the provision of the AR coating on the shield 26, can lessen the amount of unwanted radiation reflected onto the patient's tissue around the tooth especially when the shield is mounted on the gun or wand in its normal position.

It is curious that for more than a decade, these light delivery systems have been used while unsuspecting patients have on occasion stared into the almost hypnotic blue beam reflected off the safety shield. With this invention, it is believed that this problem will be lessened to at least safer levels.

1. A dental instrument for delivering light within a first wavelength band so as to cure a curable material responsive to the first wavelength band of light, comprising:
a handle and a light emitting port for emitting the first wavelength band of light; and, a substantially transparent eye protection shield adapted to be coupled to the dental instrument as a filter for blocking at least 95% of light emitted by the dental instrument, and, wherein the substantially transparent eye protection shield has an antireflective coating on at least one side thereof for preventing at least 98% of light in the first wavelength band emitted from the light emitting port incident on the substantially transparent eye protection shield from being reflected into a patient's eyes.

2. An instrument as defined in claim 1, wherein the substantially transparent eye protection shield is tinted.

3. An instrument as defined in claim 2, wherein said antireflection coating is on both sides of the substantially transparent eye protection shield.

4. An instrument as defined in claim 3, wherein the substantially transparent eye protection shield is symmetrical about a central axis and can be used by an operator from either side.

5. An instrument as defined in claim 2 wherein said antireflection coating prevents at least 99.5% of UV or blue light incident thereon from being reflected.
